(19) United States
(12) Patent Application Publication
(10) Pub. No.: US 2004/0085034 A1
(43) Pub. Date: May 6, 2004

(54) System and method for controlling a motor

(76) Inventors: Brian D. Kuras, Peoria, IL (US); Robert P. Bertsch, Peoria, IL (US); Thomas J. Nagle, Urbana, IL (US)

Correspondence Address: Finnegan, Henderson,, Farabow, Garrett & Dunner, L.L.P., 1300 I Street, N.W., Washington, DC, 20005-3315, US

(21) Appl. No.: 10/285,693

(22) Filed: Nov. 1, 2002

(51) Int. Cl. H02P 7/00

(52) U.S. Cl. 318/432

(57) ABSTRACT

A method of controlling a motor may include controllably operating a motor with a desired input command to attain a desired output response of the motor, monitoring an output of the motor, and determining a difference between the monitored output and the desired input command. The method may further include establishing a deadband around the difference and determining a torque command based on a relationship between the difference and the deadband.

### TECHNICAL FIELD

The present disclosure relates generally to a system and method for controlling a motor, engine, or the like and, more particularly, to a system and method for controlling operation of an electric motor associated with a continuously variable transmission.

### BACKGROUND

Many work machines use a continuously variable transmission to drive traction wheels or tracks which propel the work machine. In an electromechanical transmission, a power source drives an electric motor that provides a speed output to the wheels or tracks. The speed output can be continuously varied by controlling operation of the motor.

An electric motor responds more quickly to a torque command than a hydraulic motor, nearly providing instant torque. Sensors associated with the motor and/or the transmission sense parameters indicating the actual output of the motor for comparison with a desired output. Depending on the resolution of and/or noise in the sensors and/or a controller, the electric motor may experience high frequency torque oscillations, which may cause instability and/or surging of the work machine. These high frequency oscillations may cause undesirable operational noise, reduce the useful life of the motor, and/or adversely affect operator comfort.

The present invention addresses one or more of the aforementioned problems.

### SUMMARY OF THE INVENTION

In accordance with one exemplary aspect of the disclosure, a method for controlling a motor is provided. The method may include controllably operating a motor with a desired input command to attain a desired output response of the motor, monitoring an output of the motor, and determining a difference between the monitored output and the desired output. The method may further include establishing a deadband around the difference and determining a torque command based on a relationship between the difference and the deadband.

In accordance with another exemplary aspect of the disclosure, a system for controlling a motor may include a motor, a power source, and a controller. The power source may be coupled to the motor and the controller. The power source may be operable to supply power to the motor. The controller may be configured to receive a desired input command associated with a desired output response of the motor. The controller may be further configured to determine a difference between a monitored output of the motor and the desired output response, to establish a deadband around the difference, and to determine a torque command based on a relationship between the difference and the deadband.

In accordance with yet another exemplary aspect of the disclosure, a method of operating an electric drive motor is provided. The method may include controllably operating a motor with a desired input command to attain a desired output response and establishing a deadband above and below the desired output response. The deadband may have a predetermined magnitude. The method may further include monitoring an output of the motor and determining a torque command based on a relationship between the desired output response and the deadband.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this disclosure, illustrate several exemplary embodiments of the invention and, together with the description, serve to explain the principles of the invention. In the drawings,

FIG. 1 is a schematic view of an electromechanical transmission in accordance with an exemplary aspect of the invention; and

FIG. 2 is a flow chart of an exemplary operation for controlling a motor in accordance with the invention.

### DETAILED DESCRIPTION

Reference will now be made in detail to embodiments of the invention, an example of which is illustrated in the accompanying drawings. Wherever possible, the same reference numbers will be used throughout the drawings to refer to the same or like parts.

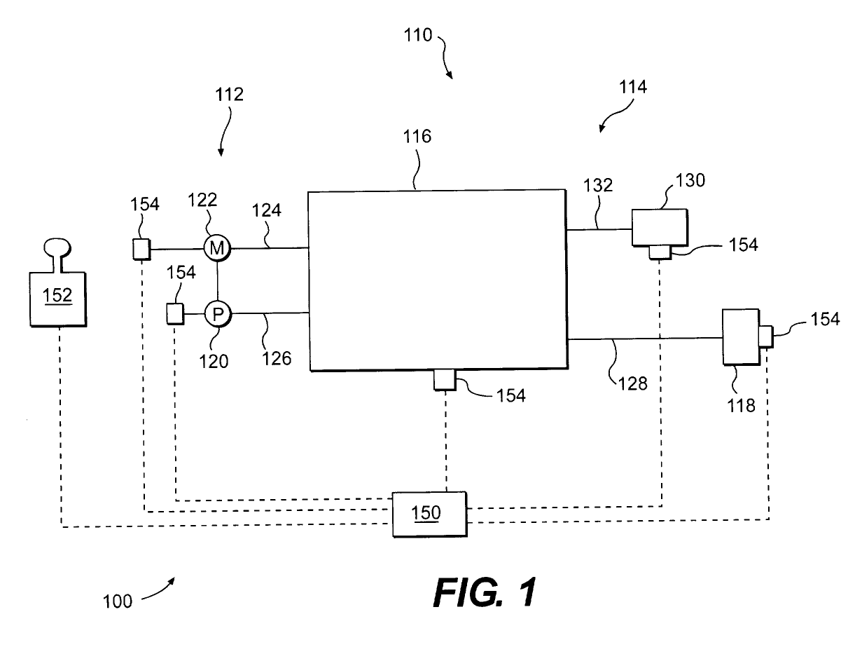

FIG. 1 is a schematic illustration of an exemplary system 100 to which the present invention can be applied. The system 100 may be equipped with a transmission 110, for example, a continuously variable transmission. The transmission 110 may have neutral, a plurality of forward gear ratios, and one or more reverse gear ratios; however, it can readily be adapted to different transmission configurations, as would be apparent to one skilled in the art.

The transmission 110 may split engine torque between an electromechanical transmission 112 and a mechanical transmission 114. The transmission 110 may be used to propel a machine (not shown) via a ground-engaging element 118. The ground-engaging element 118 may include, for example, traction wheels or tracks. The electromechanical transmission 112 may include a power source 120, for example, an electric generator, operably coupled to an electric motor 122. The mechanical transmission 114 may include a planetary gearing mechanism 116.

The motor 122 may include an output shaft 124 operably coupled to the planetary gearing mechanism 116, and the planetary gearing mechanism 116 may be operably coupled to an input shaft 126 of the power source 120, as would be apparent to one of skill in the art. The planetary gearing mechanism 116 may include one or more gears (not shown), clutches (not shown), and shafts, including an output shaft 128 coupled to the ground-engaging element 118. An engine 130 may include an output shaft 132 operably coupled to the planetary gearing mechanism 116.

The system 100 may include a controller 150 to implement closed loop control of the system 100. The control may be proportional, proportional plus integral, or proportional plus integral and differential. The controller 150 may be embodied in one or more microprocessors. Numerous commercially available microprocessors can be adapted to perform the functions of the controller 150. It should be appreciated that the controller 150 could be readily adapted to control operation of the engine 130 and the transmission 110. The controller 150 may be electrically coupled with a control lever mechanism 152, for example, an operator-controlled lever. The control lever mechanism 152 may be movable to input to the controller 150 a desired ground speed of the machine associated with the ground-engaging element 118.

The system 100 may also include one or more sensors 154 electrically coupled to the controller 150. The sensors 154 may directly or indirectly sense output of the motor 122, engine speed, engine load, and/or ground speed of the ground-engaging element 118. The controller 150 may be configured to process and/or monitor signals received from the sensors 154.

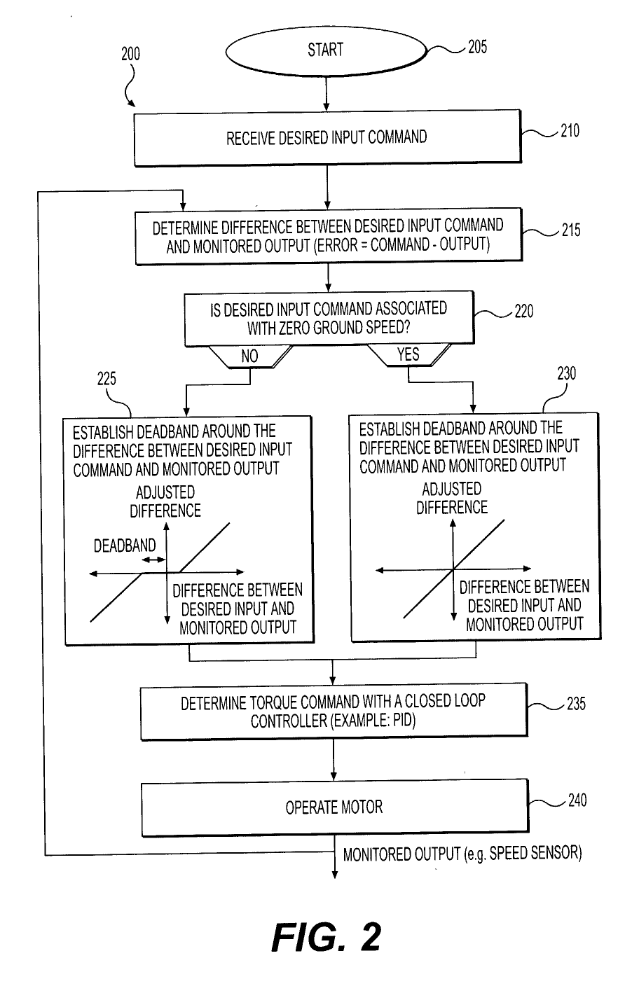

Referring now to FIG. 2, an exemplary operation 200 of the system 100 is described. The operation 200 commences at step 205 and proceeds to step 210 where the controller 150 receives desired input command, indicating a desired output of the motor 122, for example, to produce a steady-state ground speed of the ground engaging element 118.

Control then continues to step 215, where the controller 150 determines the control error or the difference between the desired input command and the monitored output of the motor 122.

Next, in step 220, the controller 150 determines whether the desired output of the motor 122 is associated with a zero ground speed of the ground engaging element 118. If, in step 220, the controller 150 determines that the desired output of the motor 122 is not associated with a zero ground speed of the ground engaging element 118, control continues to step 225. Otherwise, if the desired output of the motor 122 is associated with a zero ground speed of the ground engaging element 118, control jumps to step 230.

In step 225, the controller 150 establishes a deadband around the error or the difference between the desired input command and the monitored output. The magnitude of the deadband may be empirically determined from the system noise and/or poor resolution of the controller 150 and/or sensors 154.

In step 230, the controller does not apply a deadband around the error or the difference between the desired input command and the monitored output. This deadband is eliminated as precise control may be needed when the operator is expecting or requesting zero ground speed.

As the control proceeds, in step 235, the controller 150 determines a torque command (from adjusted difference or adjusted control error) and sends this torque command to step 240 for operating the motor 122 to generate the desired motor output, for example, to attain the desired steady-state ground speed.

### INDUSTRIAL APPLICABILITY

In operation, an operator moves the control lever mechanism 152 to command a desired ground speed of the ground-engaging element 118. The controller 150 determines a desired output of the motor 122 required to generate the desired ground speed. When accelerating or decelerating, the controller 150 varies the torque command for operating the motor 122 based on the monitored output of the motor in a feedback control system, for example, a closed loop control system.

Once the ground-engaging element 118 has reached the desired speed, it may no longer be desirable for the controller 150 to continuously vary the torque command based on minimal differences between the desired output of the motor 122 and the monitored output of the motor 122. Instead, it may be more desirable to filter out the minimal differences that may likely be attributable to poor resolution of or noise in the system 100, including the controller 150, and/or the sensors 154.

The controller 150 may be operating under predominately or exclusively proportional control when, for example, the motor 122 is an electric motor. In many industrial applications, the overall gain (or proportional gain) of the controller may be required to be high due to the response requirements of the machine. Therefore, a small control error possibly attributable to poor resolution or noise may cause the controller 150 to continuously vary the torque command to attempt to attain the desired steady-state output. As a result, the motor output may over-respond and continuously oscillate around the desired steady state output. In addition, it is possible, depending on the operational frequency of the controller 150 and the necessary frequency response determined by the controller, the system 100 may over-respond and become unstable. By establishing a deadband around the torque command for attaining the desired steady state output of the motor, the controller 150 is forced not to respond to small control errors possibly attributable to the poor resolution or noise.

Furthermore, the controller 150 may be configured to remove the deadband where small control errors should be considered. For example, when an operator commands negligible ground speed of the ground-engaging element 118, the controller 150 determines an appropriate motor output. Since it is not desirable for the ground-engaging element 118 and an associated machine to creep, zero steady state error is required. Therefore, when the desired output of the motor is associated with zero ground speed of the ground-engaging element 118, the controller 150 does not implement the deadband. As a result, the controller 150 may continuously vary the torque command for operating the motor 122 to attain the desired motor output.

A system and method for controlling a motor in accordance with exemplary embodiments of the invention may reduce instability and/or surging of the work machine possibly associated with poor resolution of and/or noise in the system 100. Further, the system and method may reduce undesirable operational noise, increase the useful life of the motor, and/or improve operator comfort. The system and method may also avoid creep of the ground-engaging element 118 by achieving zero steady state error when zero ground speed is commanded.

It will be apparent to those skilled in the art that various modifications and variations can be made in the disclosed system and method for controlling a motor without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. A method of controlling a motor, comprising:
controllably operating a motor with a desired input command to attain a desired output response of the motor;
monitoring an output of the motor;
determining a difference between the monitored output and the desired input command;
establishing a deadband around the difference; and
determining a torque command based on a relationship between the difference and the deadband.

2. The method of claim 1, wherein determining a torque command includes modifying the desired input command at times when the magnitude of the difference is greater than the deadband.

3. The method of claim 2, wherein the torque command is increased at times when the monitored output is less than the desired input command by more than the deadband.

4. The method of claim 2, wherein the torque command is decreased at times when the monitored output is greater than the desired input command by more than the deadband.

5. The method of claim 1, wherein the deadband is eliminated when the desired output response is associated with zero ground speed of a ground-engaging element coupled to the motor.

6. The method of claim 1, wherein said controllably operating includes proportional control.

7. The method of claim 1, wherein said controllably operating includes proportional plus integral control.

8. The method of claim 1, wherein said controllably operating includes proportional plus integral and differential control.

9. A system for controlling a motor, comprising:
a motor;
a power source coupled to the motor, the power source being operable to supply power to the motor; and
a controller coupled to the power source, the controller being configured to receive a desired input command associated with a desired output response of the motor, the controller being further configured to determine a difference between a monitored output of the motor and the desired output response, to establish a deadband around the difference, and to determine a torque command based on a relationship between the difference and the deadband.

10. The system of claim 9, wherein the controller determines a torque command by modifying the desired input command.

11. The system of claim 10, wherein the controller is configured to increase the torque command at times when the monitored output is less than the desired input command by more than the deadband.

12. The system of claim 10, wherein the controller is configured to decrease the torque command at times when the monitored output is greater than the desired input command by more than the deadband.

13. The system of claim 9, wherein the deadband is eliminated when the desired output response is associated with zero ground speed of a ground-engaging element coupled to the motor.

14. The system of claim 9, wherein the controller includes proportional control.

15. The system of claim 9, wherein the controller includes proportional plus integral control.

16. The system of claim 9, wherein the controller includes proportional plus integral and differential control.

17. A continuously variable transmission, comprising:
the system of claim 9; and
a planetary gearing mechanism coupled to the motor.

18. A machine comprising:
the continuously variable transmission of claim 17;
an engine coupled to the continuously variable transmission; and
at least one ground-engaging element mechanically coupled to the continuously variable transmission.

19. A method of operating an electric drive motor, comprising:
controllably operating a motor with a desired input command to attain a desired output response;
establishing a deadband above and below the desired output response, the deadband having a predetermined magnitude;
monitoring an output of the motor; and
determining a torque command based on a relationship between the desired output response and the deadband.

20. The method of claim 19, further including eliminating the deadband when the desired output response is associated with zero ground speed of a ground-engaging element coupled to the motor.
